(19) United States
(12) Patent Application Publication
(10) Pub. No.: US 2009/0024536 A1
(43) Pub. Date: Jan. 22, 2009

(54) Methods and Systems for Reconciling Profit and Loss

(75) Inventors: Wesley D. Archer, Yonkers, NY (US); Jeffrey Lathrop, Park Ridge, NJ (US); Harjinder Sidhu, Somers, NY (US); Craig Sher, Wyckoff, NJ (US)

Correspondence Address: KALOW & SPRINGUT LLP, 488 MADISON AVENUE, 19TH FLOOR, NEW YORK, NY, 10022, US

(73) Assignee: AlaS, Inc., Elmsford, NY (US)

(21) Appl. No.: 11/780,559

(22) Filed: Jul. 20, 2007

(51) Int. Cl. G06Q 40/00

(52) U.S. Cl. 705/36 R; 235/379

(57) ABSTRACT

In various embodiments, a network based system for reconciling financial data to a general ledger is provided, which comprises a financial data module configured to receive or transmit data from a front office and/or back office concerning a financial transaction or instrument; an adjustments module coupled to the financial data module configured to adjust the data received or transmitted from the front office and/or back office; a tracking module coupled to the financial data module configured to track adjustments made to the financial data; a reconciling module coupled to the data module configured to reconcile financial data from the front office and/or back office; and a lock down and signoff module coupled to the financial data module configured to prevent altering of the financial data and allow an authorized user to provide a digital signature to verify the integrity of the financial data at a close of business day.

### BACKGROUND

The financial services industry uses spreadsheets and commercially available database programs, such as EXCEL and ACCESS, to handle data manipulation, reconciliation and the control of both front, back office and general ledger environments.

However, the financial systems available, while being able to store and reconcile front, back office and general ledger activity, do this reconciliation in a batch, business day plus one or more environments. Often a company cannot accurately determine their financial status in “real time.”

Without the ability for “real time” reconciling, serious questions about the risks associated with financial transaction or financial instruments come into play. For example, market factors (e.g., interest rates, fluctuations, market value, etc.) may conceal real value of the financial institution or instrument, which may result in unexplained loss to the company.

Now after Sarbanes-Oxley legislation and mandated financial disclosures, there is an ever-increasing need for CEOs to keep updated on the company's accounting and auditing standards and financial reports.

Based on the above, there is a need in the art for improved methods and systems for reconciliation, including front office to front office reconciliation, and improved methods and systems for front office to back office reconciliation and back office to general ledger reconciliation. Further, there is a need in the art for methods and systems that can effectively track input in reconciliation systems, particularly in connection with profit and loss adjustments on a continuous basis.

### SUMMARY

In various embodiments, the present invention is based at least in part that successful management of a financial services operation would benefit from a system that tracks changes to profit and loss (P&L) in the back office (BO), in the front office (FO), and GL and is capable of reconciling front office estimate and front office actual (FOFO) input, and front office and back office (FOBO) input, and back office and GL information to generate accurate and controlled profit and loss information. This reconciliation is designed to take place at a trade or position level.

In various embodiments, the present invention is also based at least in part on a reconciliation system that reconciles front office activities in a financial institution at various times during a trading day by, for example, a back office system (i.e., FOFO reconciliation). In various embodiments, the reconciliation includes profit and loss reconciliation for at least one time point prior to the close of a trading day (i.e., at a time T=0).

In various embodiments, the present invention is also based at least in part on controlled input of data into a reconciliation system that is desirable, in particular but not limited to controlled input of adjustments. Controlled input of adjustments includes, for example, tracking activity and identifying users inputting data that are used to make adjustments to data that will be employed in determining P&L at T=0 or T=1. In various embodiments, the adjustments are tracked and users identified before the end of the trading day, at a time T=0. In various embodiments, adjustments are tracked and users identified throughout the trading day.

The present invention is also based at least in part on a reconciliation system with an expansive assortment of adjustments to P&L. In various embodiments, the adjustments include adjustments for price, internal transfer price, cost, funding estimate, position, and/or provision adjustments. In various embodiments, the adjustments are made at a time T0, or at a time T1 as appropriate.

In various embodiments, the present invention is also based at least in part on a double entry bookkeeping system and method for making adjustments, including but not limited to adjustments made at a time T=0. In various embodiments, the double entry bookkeeping methods and systems include controlling changes to a P&L and controlling changes to a balance sheet.

A system is described that, in various embodiments, provides support for generating P&L information based on front office activities, back office activities, and front office-back office (FOBO) reconciliation. Methods and systems are provided that include a P&L reconciliation strategy that can be employed during a trading day (i.e., at a time T=0 or T0) or the day after the close of a trading day (i.e., at a time T+1 or T1). In various embodiments, the methods and systems provide an improved control architecture in front office and back office environments. In various embodiments, methods and systems are provided that reconcile front office activities with front office activities (e.g., reconciliation of activities at different T0 time points), front office activities with back office activities, and improved reconciliations to general ledger functions in front office, back office, or front office and back office environments.

In the summary that follows, any of the embodiments disclosed in connection with a particular or feature of the invention can also be used in connection with any other particular or suitable feature of the invention unless otherwise indicated.

In various embodiments, a double entry bookkeeping module is provided for a front office financial data reconciliation system, comprising a computer-readable array of fields comprising data in connection with a financial transaction or a financial instrument, the computer-readable array comprising a plurality of fields pre-populated with static data and fields to enter data to be reconciled that is associated with the financial transaction or financial instrument, wherein the double entry bookkeeping module is configured to allow the data to be reconciled during a trading day prior to the close of trading or after the trading day is complete or the following day (T+1).

In various embodiments, a system is provided for reconciling financial data including profit and loss data, comprising: a) identifying an asset for purchase; b) identifying an internal source of funding for purchase of the asset; c) assigning an internal transfer price to the internal source of funding for the purchase of the asset, wherein the internal transfer price is treated by the system as a cost; d) generating a funding estimate that includes the internal transfer price treated as the cost; and e) reconciling the financial data including profit and loss associated with the asset purchase using the funding estimate.

In various embodiment, a system is provided for reconciling financial data in a front office environment, comprising: (a) obtaining a first front office data input into a database prior to close of a trading day, wherein the first front office data input comprises at least a first tracked adjustment; (b) obtaining a second front office data input into a database prior to the close of the trading day, wherein the second front office data input comprises at least a second tracked adjustment; (c) locking down and signing off the first front office data input and the second front office data input and storing it in the database; and (d) performing a reconciliation between the first front office data input and the second front office data input, wherein the reconciliation includes at least one of the first tracked adjustment and the second tracked adjustment.

In various embodiments, a network based system is provided for reconciling financial data to a general ledger, the system comprising: a financial data module configured to receive or transmit data from a front office and/or back office concerning a financial transaction or a financial instrument; an adjustments module coupled to the financial data module configured to adjust the data received or transmitted from the front office and/or back office; a tracking module coupled to the financial data module configured to track adjustments made to the financial data; a reconciling module coupled to the data module configured to reconcile financial data from the front office and/or back office; and a lock down and signoff module coupled to the financial data module configured to prevent altering of the financial data and allow an authorized user to provide a digital signature to verify the integrity of the financial data at a close of business day.

In various embodiments, a computer readable storage medium is provided for storing instructions that, when executed by a computer, cause the computer to receive or transmit financial data from a front office and/or back office concerning a financial transaction or a financial instrument; adjust the data received or transmitted from the front office and/or back office; track adjustments made to the financial data; reconcile financial data from the front office and/or back office; and prevent altering of the financial data and allow an authorized user to provide a digital signature to verify the integrity of the financial data at a close of business day.

Additional features and advantages of various embodiments will be set forth in part in the description that follows, and in part will be apparent from the description, or may be learned by practice of various embodiments. The objectives and other advantages of various embodiments will be realized and attained by means of the elements and combinations particularly pointed out in the description and appended claims.

### BRIEF DESCRIPTION OF THE FIGURES

FIG. 1 illustrates a simplified diagram of one embodiment of the system and methods for reconciling profit and loss using the database with different modules and user interface that allows access to the database.

FIG. 2 illustrates the information exchange, in one embodiment, of the methods and systems for reconciling profit and loss at a point in time T0 (one or more points in time at the beginning of the trading day but not after the close of the trading on that day).

FIG. 3 illustrates the information exchange, in one embodiment, of the methods and systems for reconciling profit and loss at a point in time T1 (one or more points in time after the close of the trading on that day).

FIG. 4 illustrates one embodiment of the methods and systems for reconciling profit and loss at points in time T0, T1 and T2 (sometime after T1).

It is to be understood that the figures are not drawn to scale. Further, the relation between objects in a figure may not be to scale, and may in fact have a reverse relationship as to size. The figures are intended to bring understanding and clarity to the structure of each object shown, and thus, some features may be exaggerated in order to illustrate a specific feature of a structure.

### DETAILED DESCRIPTION

Reference will now be made in detail to certain embodiments of the invention, examples of which are illustrated in the accompanying drawings. While the invention will be described in conjunction with the illustrated embodiments, it will be understood that they are not intended to limit the invention to those embodiments. On the contrary, the invention is intended to cover all alternatives, modifications, and equivalents, which may be included within the invention as defined by the appended claims.

It is noted that, as used in this specification and the appended claims, the singular forms “a,” “an,” and “the,” include plural referents unless expressly and unequivocally limited to one referent. Thus, for example, reference to “a user” includes one, two, three or more users.

The headings below are not meant to limit the disclosure in any way; embodiments under any one heading may be used in conjunction with embodiments under any other heading.

### Database

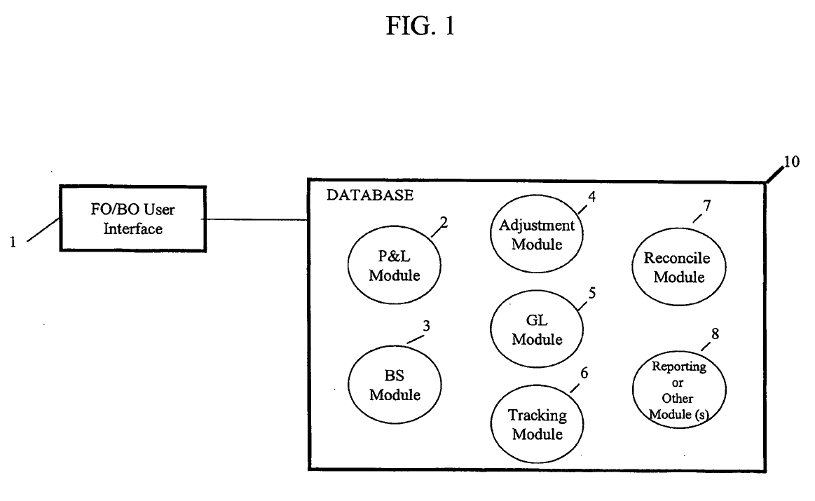

In various embodiments, the database (10 in FIG. 1) includes at least one of: a P&L module (2), adjustments module (4), reconciling module (7), GL module (5), tracking module (6), BS module (3), reporting modules (8) and other modules (e.g. lock down and signoff module, alerts generator module, etc.). The individual module may control processing of the individual searching and/or organizing operations described in (or apparent from) the instant disclosure. Each module may be one or more processors or processor-based systems executing one or more executable programs (locally or remotely) stored in a memory component (or other article of manufacture.

The modules described herein, particularly those illustrated or inherent in the instant disclosure, may be one or more hardware, software, or hybrid components residing in (or distributed among) one or more local or remote computer systems. Although the modules may be shown or described herein as physically separated components (e.g., P&L module 26, lock down and sign off module 34, estimated reports module 28, etc.), it should be readily apparent that the modules as described herein may be merely logical constructs or routines that are implemented as physical components combined or further separated into a variety of different components, sharing different resources (including processing units, memory, clock devices, software routines, logic commands, etc.) as required for the particular implementation of the embodiments disclosed. Indeed, even a single general-purpose computer (or other processor-controlled device) executing a program stored on an article of manufacture (e.g., recording medium or other memory units) to produce the functionality referred to herein may be utilized to implement the illustrated embodiments.

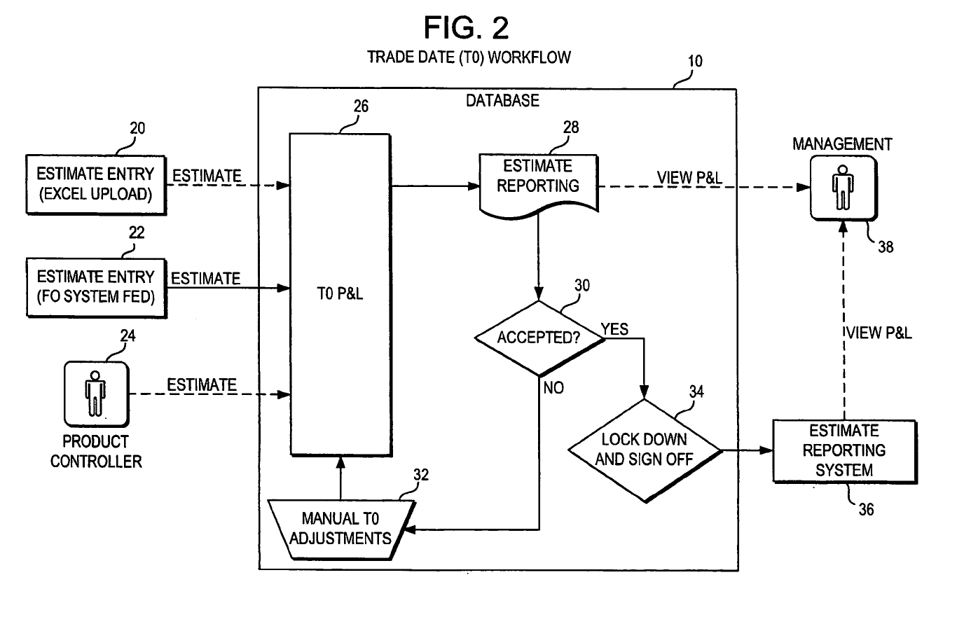

The database comprising at least one module is accessible by one or more user interfaces (e.g., 1 in FIG. 1, 24, 38 individual user in FIG. 2 (e.g., product controller, management, administrator and/or 20, 22 organizational user). If the user has the proper authorization, the user will enter their password and user id to have access to the database or utilize the network database.

Database hardware and software have been developed for access by users through personal computers, mainframes, and other processor-based devices. Users may access and view P&L, BS, adjustments, and GL information stored locally on hard drives, CD-ROMs, stored on network storage devices through a local area network, or stored on remote database systems through one or more disparate network paths (e.g., the Internet). The database has a security module, which is configured to protect the database from access by unauthorized users (e.g., hackers, viruses, worms, spy ware, etc.).

Database (10 in FIG. 1) may be any one or more of the known storage devices or systems (e.g., Random Access Memory (RAM), Read Only Memory (ROM), hard disk drive (HDD), floppy drive, zip drive, compact disk-ROM, DVD, bubble memory, redundant array of independent disks (RAID), network accessible storage (NAS) systems, storage area network (SAN) systems, etc.). The database may also comprise one or more memory devices embedded within a CPU, or shared with one or more of the other components, and may be deployed locally or remotely relative to one or more components interacting with the memory or one or more modules.

The different information (P&L, BS, GL, adjustments, estimates, etc.) may be stored as a continuous set of data, segmented to form a contiguous whole, or separated into different segments to reside in and among one or more server databases, as well as partitioned for storage in one or more files to achieve efficiencies in storage, access, and processing of data. The information may be stored in one or more database structures for use in their raw, natural, or unmodified data states (e.g., as delivered from the data source). Data may be stored in a variety of formats including document types such as, HTML, TXT, PDF, RTF, TIF, Word, WordPerfect, Excel, Access, etc.

In various embodiments, the database employs PL/SQL, ORM, Struts, and/or other routines to easily manage and update the database. In various embodiments, the system employs MVC routines that separates data from the user interface so that changes in the data do not affect the user interface, and vice versa.

In network based systems, the computer network may take any wired/wireless form of known connective technology (e.g., corporate or individual LAN, enterprise WAN, intranet, Internet, Virtual Private Network (VPN), combinations of network systems, etc.) to allow the network server to provide local/remote information and control data to/from other locations (e.g., other remote database servers, remote databases, network servers/user interfaces, etc.). In accordance with a preferred embodiment, network server may be serving one or more users over a collection of remote and disparate networks (e.g., Internet, intranet, VPN, etc.).

### User

It should be readily apparent that a “user” of the various aspects of the inventive systems and methods disclosed herein may be any author or recipient of information. For example, a user may be one or more of the same or different individuals (e.g., controller, trader, manager, administrator, business entity, etc.), or a combination of the same or different individuals, or entities.

User interfaces (e.g., 24, 38, 142, 148, etc.) may include one or more display devices (e.g., CRT, LCD, or other known displays) or other output devices (e.g., printer, etc.), and one or more input devices (e.g., keyboard, mouse, stylus, touch screen interface, or other known input mechanisms) for facilitating interaction of a user with the database. As illustrated, in the figures (e.g., FIG. 1 (1)), the user interface may be directly coupled to database 10, or directly coupled to a network server system.

In accordance with a preferred embodiment, one or more user interfaces are provided as part of (or in conjunction with) the illustrated systems to permit users to interact with the systems. The user interface device may be implemented as a graphical user interface (GUI) containing a display or the like, or may be a link to other user input/output devices known in the art. Individual ones of a plurality of devices (e.g., network/stand-alone computers, personal digital assistants (PDAs), WebTV (or other Internet-only) terminals, set-top boxes, cellular/phones, screen phones, pagers, blackberry, peer/non-peer technologies, kiosks, blackberry, or other known (wired or wireless) communication devices, etc.) may similarly be used to execute one or more computer programs (e.g., universal Internet browser programs, dedicated interface programs, etc.) to allow users to interface with the systems in the manner described.

In various embodiments, the database comprises a search module to search having a search engine to search the database. The search engine may provide text-based, graphics-based, code-based, or other search/query mechanisms to produce search results to be viewed, accessed, edited, or otherwise output to be saved in the database or viewed by a user. In one embodiment, for example, the search module performs searches based on input data such as: keywords; text or graphics in select fields (e.g., account, debit, credit, entity, dollar amount, etc.); Boolean logic characters, or other search criteria (e.g., date restrictions, etc.).

In various embodiments, the database comprises a retrieving module to retrieve searches and a display module configured to download information to be displayed on a user interface and a reports and/or printing module configured to print information at one or more user interfaces. The reports module generates various reports requested by the user. These can be very detailed reports or snap shot summaries about the business, transaction, financial institution and/or financial instrument.

In various embodiments, the database makes the search results (and any available underlying documents listed) available for viewing or other output (e.g., print, e-mail, fax, etc.) by the user (or user interface). The search results may be ordered, sorted, and saved in accordance with one or more known order preferences set by a user (e.g., date, alphabetical by account, entity, amount, etc.). In accordance with one embodiment, the resulting information (i.e., journal entry, adjustment and/or available underlying documents) may be downloaded in one or more textual/graphical formats (e.g., RTF, PDF, TIFF, etc.), or set for alternative delivery to one or more specified locations (e.g., via e-mail, fax, regular mail, courier, etc.) in any desired format (e.g., print, storage on electronic media such as CD-ROM, etc.). The user may view the search results and underlying documents at the user interface, which allows viewing of one or more documents on the same display, as well as viewing of one or more portions or segments, summaries, or information fields of different documents separately or together so as to facilitate analysis of the search results.

In various embodiments, the database comprises a reports module (alone or in conjunction with other modules) to generate reports concerning the financial transaction, financial instrument, P&L, BS, GL, adjustments and/or estimates. The reports module, for example, may be programmed to allow users to create and store templates or other forms, which can be populated during report generation. Reports may then be generated manually or automatically from selected data sets (e.g., manual adjustments, automatic adjustments, account, P&L, BS, GL entry, etc.).

In various embodiments, the database may have an alerts generator. When alerts are employed, an alert generator can notify one or more users that a certain predetermined event is approaching for the particular financial transaction or financial instrument (e.g., foreign exchange rate drops, T1 adjustments made, lock down and signoff occurred, funding estimate, etc.). The alert generator may be used (alone or in conjunction with other modules) to P&L, BS, adjustments, and/or GL data and notify one or more users of the event (e.g., minute by minute, second by second, hourly, daily, weekly, monthly, etc.). In various embodiments, the alert generator can be programmed to provide an alert to a user by sending an e-mail message, text message, voice mail message, pager message, facsimile message, or other mechanism (or combination of such mechanisms) to the specified by the user.

In various embodiments, the alerts generator is configured to monitor pre-trade, post-trade, and real-time market value for the financial transaction or instrument.

### Double Entry Bookkeeping

In various embodiments, a double entry bookkeeping module is provided for a front office financial data reconciliation system, comprising a computer-readable array of fields comprising data in connection with a financial transaction or a financial instrument, the computer-readable array comprising a plurality of fields pre-populated with static data and fields to enter data to be reconciled that is associated with the financial transaction or financial instrument, wherein the double entry bookkeeping module is configured to allow the data to be reconciled during a trading day prior to the close of trading. In various embodiments, the reconciling is done continuously throughout the trading day, unlike one time batch processing of the prior art. Typically, the trading day or T0 includes a period of time from 0000 hours until 2400 hours on any day. In various embodiments, the trading day includes market hours of generally 9:30 AM to 4:00 PM excluding Saturdays, Sundays and holidays.

A double-entry bookkeeping system, in various embodiments, is a way of record keeping of financial events or transactions where each transaction has a dual aspect, one of which gives rise to a debit entry, the other to a credit entry. Double-entry bookkeeping includes recording each transaction in at least two accounts. In the double-entry system, each transaction results in at least one account being debited and at least one account being credited. It is a requirement that the total debits of the transaction equal the total credits. The benefit of the system is that the accuracy of the accounts can be checked quickly—for example, when all the accounts that have debit balance are summed, they should equal the sum of all the accounts, which have a credit balance. Double-entry bookkeeping reduces data entry errors. In the double-entry bookkeeping system, the data records are stored and saved in the database and can be searched, retrieved, adjusted, edited, and displayed at one or more user interfaces in any format (electronically, paper, on screen, etc.).

Front office (FO) includes the part of the financial services that executes transactions for the cash investment, funding, foreign exchange, risk hedging, and trading activities for the company. The front office interfaces with the group's entities or subsidiaries and provides financial services to them, and interacts most with the company's lenders and other financial counterparties. The front office may edit, save, and send data concerning debit or credit, balance sheet, profit or loss entry, adjustments, to the back office or middle office or to the front office for reconciling.

Back office (BO) includes the administrative functions that support the trading, including trade confirmation and settlement, recordkeeping, and regulatory compliance. More generally, back office includes administrative functions that support but are not directly involved in the operations of a business, such as accounting and personnel. Typically, the back office administers and supports the trading activities of the front office. In various embodiments, the back office's functions include processing, confirming, verifying, settling, reconciling and recording financial market transactions. The back office is also responsible for ensuring that the organization's management policies and controls are followed as well as ensuring general compliance with rules and regulations. The back office may edit, save, and send data concerning debit or credit, balance sheet, profit or loss entry, adjustments, to the front office or middle office or the back office for reconciling.

The middle office is the group of employees in a financial services company that manages risk, assists in the calculation profits and losses, and (generally) is in charge of information technology. The middle office draws on the resources of both the front office (sales personnel and corporate finance) and the back office (administration and support). The middle office may edit, save, and send data concerning debit or credit, balance sheet, profit or loss entry, adjustments, to the back office, middle office or front office for reconciling.

The system and methods provided reconcile entries to accounts and resolves differences so that for any given date, time on the register, the last balance is exactly the same as ending balance on the statement for that same date. The system and methods provided allows this to happen in “real time.” Thus, capturing and reporting data, immediately, or without perceived delay to the user after the financial transaction occurs. In various embodiments, the reconciling and adjustments can occur on a continuous basis. Typically, a financial transaction involves a change in the status of the finances of two or more businesses or individuals.

FIG. 2 illustrates the information exchange, in one embodiment, of the methods and systems for reconciling profit and loss at a point in time T0 (one or more points in time at the beginning of the trading day but not after the close of the trading on that day). Front office (FO) data is transmitted into the database (10) including the profit and loss data concerning a financial instrument of financial institution at T0. The data is transmitted from one or more user interfaces. For example, the data transmitted can be an estimate entry from, for example, a FO Excel upload (20) or from the FO system feed (22) having multiple FO transaction entries or it may be an estimated transaction from the controller (24). The estimates are stored in the database in the TO P&L module (26) and all data feeds from the FO (e.g., 20, 22, and/or 24) are reconciled (FO to FO reconciliation) and an estimate report (28) is generated from the estimated data, which is displayed at one or more user interfaces and can be accepted or rejected by the controller (24) or management (38). If the data is not accepted manual adjustments (32) to the data may be made by the controller (24) or management (38). The controller and/or management will have the authorized level to access the database to make such adjustments. It will be understood that the controller and/or manager can be the same or different users. The controller and/or manager can be one, two, three or more different users. These adjustments may be made, for example, by entering adjustments to price, P&L, position and funding. Typically, position adjustments include adjustments to securities or commodities held by a person, firm, or institution. They can include adjustments, for example, for a missed trade. Position adjustments often involve adjustments for contracts that are bought or sold for which no offsetting transaction has been entered into.

Provision adjustments include adjustments to the financial instrument and/or financial institution for future loss or gain that one expects in the future but has not yet realized (e.g., loss or gain due to a upcoming court decision). Funding adjustments typically include income and expenses relating to cash funds of a business's trading activities. The funding adjustment may have an internal borrowing or lending cost associated with the adjustment. Once the estimated reporting for that period is complete at T0, an authorized user (e.g., management, controller, etc.) can lock down and electronically signoff (34) on the data in the system with, for example, a digital signature, where further alterations to the data can not be made. In this way the integrity of the data is assured. The management can run and view the estimated report (36) at the user interface at various times of the day, before, during and after lock down and sign off. In this way, a continuous process of reporting can occur.

Lock down functions of the system typically turns off unnecessary features and provides multi layers of protection to the database from unauthorized users. When lock down is initiated for the database, outward flow of information out of the database is prevented, for example, Internet access, and internal applications are denied. After lockdown the data cannot be changed and remains a permanent record. In various embodiments, after lock down, new financial transactions cannot be entered into the database.

Signoff, log off, log out, or disconnecting, includes the process of disconnecting from the database or network service and the authorized user can put their digital signature, digital certificate or electronic signature that guarantees the integrity of the database or the financial record or transaction.

In various embodiments, the estimates transmitted (20, 22) to the database can be a systematic transaction feed from other interfaces, or the web interface or it can be an upload from a access or excel or any other front office upload interface.

In various embodiments, adjustments include journal entries usually done at a specified date/time to allocate revenue and expenses to the period, which they are applicable to (TO or T1).

The database allows journal entries to be entered into the system. Typically, journal entries include business transactions and their monetary value that are entered into the double-entry bookkeeping system as either debits or credits. Journal entries are usually backed up with evidence of the transaction (e.g., electronic transfer, a piece of paper saved electronically in the database; a receipt, a bill, an invoice, or some other direct record of the transaction that can be scanned and associated with the entry); making them easy to record and to maintain traceability for each transaction. Typically, journal entries include date, time, name of account being credited, name of account being debited, user, and metadata and other information associated with the transaction. Any journal entry can be edited, stored and saved in the database and can be searched, retrieved and displayed at one or more user interfaces in any format (electronically, paper, on screen, etc.).

A balance sheet (BS) includes a statement of the book value of all of the assets and liabilities (including equity) of a company or other organization or person at a particular date and point in time. It is known as a balance sheet because it reflects an accounting identity. The components of the balance sheet typically are equal, or in balance; in the most basic formulation: assets must equal liabilities, or assets must equal debt plus equity. A balance sheet can provide a “snapshot” of the company's financial condition on a given date and/or time. The balance sheet data can be edited, stored and saved in the database and can be searched, retrieved and displayed at one or more user interfaces in any format (electronically, paper, on screen, etc.).

Profit and loss statement (P&L) (also called an income statement) includes a financial statement for companies that indicates how net revenue (money received from the sale of the financial asset and/or instrument before expenses are taken out, also known as the “top line”) is transformed into net income (the result after all revenues and expenses have been accounted for, also known as the “bottom line”). The P&L statement shows whether the company made or lost money during the period being reported (e.g., day, hour, minute, second, month, quarter, etc.). The P&L statement data can be edited, stored and saved in the database and can be searched, retrieved and displayed at one or more user interfaces in any format (electronically, paper, on screen, etc.).

A general ledger (GL) includes an accounting record or legend in which are listed increases or decreases of accounts such as liability, reserve, capital, income and expense accounts. The GL is the main accounting record of a business, which uses double-entry bookkeeping. It will usually include accounts for such items as current assets, fixed assets, liabilities, revenue and expense items, gains and losses. Typically, the GL is a list of all or substantially all of the transactions that occur in the company. It is built up by posting transactions recorded in the general journal. Typically, there are at least five basic categories in which all accounts are grouped: asset, liability, owner's equity, revenue, and expense. The basic categories of the general ledger may be further subdivided into sub-ledgers to include additional details of such accounts as cash, accounts receivable, accounts payable, etc. The balance sheet (BS) and the P&L statement are both derived from the general ledger. The general ledger is where posting to the accounts occurs. Posting is the process of recording amounts as credits, (right side), and amounts as debits, (left side), in the pages of the general ledger. The listing of the account names and the sum of the account balances is called a trial balance. The purpose of the trial balance is, at a preliminary stage of the financial statement preparation process, to ensure the equality of the total debits and credits. Typically, the GL includes the date, description and balance or total amount for each account, and can include metadata associated with it. The GL can be edited, stored and saved in the database and can be searched, retrieved and displayed at one or more user interfaces in any format (electronically, paper, on screen, etc.).

Adjustments include edits to journal entries to allocate for, example, revenue and expenses to the financial transaction and/or instrument. Adjustments may include accruals, for example, revenue and expenses that are matched to dates/time before the transaction has been recorded. Adjustments may include deferrals for revenue and expenses that are matched to dates/times after the transaction has been recorded. Typically, adjustments entries include date, time, account title, adjustment, user, metadata associated with the adjustment and other information associated with the transaction. Adjustments are done because normal journal entries are based on actual transactions, and the date when transactions occur may not be the date to fulfill matching principles (e.g., debits equaling credits). In various embodiments, the adjustments are made using the adjustments module; for example, source data cannot be changed unless it is done through the adjustments module. The adjustments are made to the transaction and the tracking module will track the adjustments by time stamp, user identification (e.g., digital signature), and/or metadata associated with that adjustment. In various embodiments, T0 estimate adjustments allows, for example, the user to adjust T0 P&L for late trades or mis-pricing.

In various embodiments, the tracking module allows tracking of text data, meta data, binary data, still image data, moving image data, and audio data, day, month, year, hour, minute, second, user id associated with the financial transaction or financial instrument. In various embodiments, the tracking module will date and time stamp every entry. In this way there is an audit trail for different transactions. The tracking module allows an authorized user to see who made the entry, when and what was the entry, etc.

In various embodiments, the T0 estimate reporting includes the trade date, estimated P&L, viewed through user interface, or portfolio/transaction drill down. Typically, drill down is the ability to move from summary information through intermediate summaries to the lowest level of details (e.g., individual, trade, or position information) stored in the database for the business entity or financial transaction. The T0 estimate reporting can also include lock down and signoff on the estimate data. In various embodiments, the estimate data can have a full audit trail including date and time stamp and user signoff.

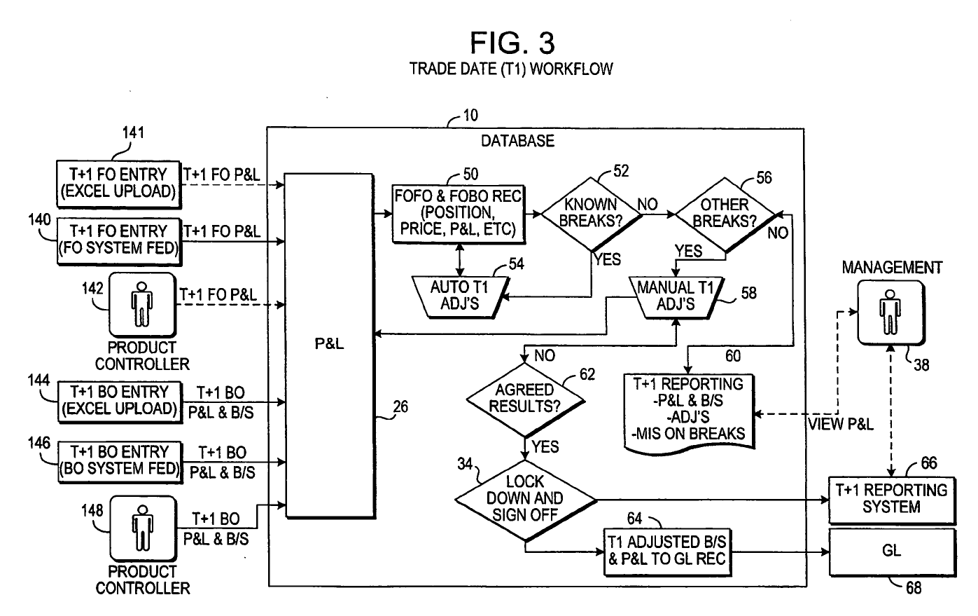

FIG. 3 illustrates the information exchange, in one embodiment, of the methods and systems for reconciling profit and loss at a point in time T1 (some time after the close of the trading day, which is after T0). Front office (FO) data at time T1 is transmitted into the database (10) including the P&L data (26) concerning one or more financial transactions or financial instruments. The data is transmitted from one or more user interfaces. For example, the data transmitted can be, for example, a T1 FO P&L entry in an Excel upload (141) or from the T1 FO entry from a system feed (140) having multiple FO transaction entries or it may be a T1 FO P&L transaction from the controller (142), or a T1 BO P&L and/or BS entries from one or more Excel uploads (144) or T1 BO P&L and/or BS entries from one or more data feeds (146) and/or T1 BO P&L and/or BS entries from the controller (148). The data is stored in the database in the P&L module (26) and all data feeds from the FO, BO and/or controller (e.g., 38, 140, 142, 144, 146, and/or 148) are reconciled in reconciling module (50) (e.g., FO to FO, FO to BO, P&L, and/or BS reconciliation). If there are known breaks (52) in the entries (e.g., mis-pricing, wrong entries, etc.) the system has a routine that will automatically adjust (54) those breaks. If there are no known breaks in the entries, the system will determine if there are other breaks (56) (e.g., position differences, price differences, P&L differences, etc.) that are noted by management, the controller or the system. If there are other breaks, manual adjustments (58) at time T1 will be made by management (38) or controllers (142 and 148). The manager and/or controller will agree on the adjustments (62) and have the authorized level to access the database to make such adjustments. The adjustments are then stored in the database. If there are no other breaks, the system will generate a report (66) of the P&L, BS and adjustments (60) that management (38) and/or controller can review. If management and/or controller agree with the report, then lock down and signoff (34), with for example, a digital signature on the data in the system can be made. After lock down and signoff further alterations to the data cannot be made. In this way the integrity of the data is assured. The data including adjusted BS, P&L all are recorded (64) and sent to the GL for recording (68). It will be understood that the controller and/or manager can be the same or different user or person. The controller and/or manager can be one, two, three or more different or the same user.

In various embodiments, a trade is entered into the front office trading system. Towards the end of the trading day, the front office trading system may create an estimated position and P&L. Typically, an estimated position is an estimate created based on front office information prior to the end of the trading day T0 or after the trading day T1 or after the trading day is complete, but before the FO system has been closed or locked down has occurred for financial transaction entry. This estimate is sent to and saved in the database. The user of the front office system will run an end of day process that produces a flash position and P&L or a snap shot of the position and P&L, which is also sent and stored in the database. During overnight processing, the system will reconcile these two positions and P&L entries. Any differences can be adjusted by the product controller in the application with a full audit trail. The back office system, during its end of day process will also create a position and P&L data that will be sent to the database. This will be reconciled at a trade level to the front office data. Again the product controller can create adjustments in the system to fix breaks. The GL will send information to the trial balance sheet. This will in turn be reconciled to the adjusted back office position and P&L. Adjustments will again be created by the product controller to correct any differences.

In various embodiments, the TO and T1 FOFO reconciliation (50) captures late trade P&L data. The T1-BO entry allows position and transaction fees to the database, and/or it can be uploaded from Excel or other interface or from a web based interface. In various embodiments, the system allows FO to BO P&L components to be reconciled. In various embodiments, the system provides for T1 auto adjustments that occur in real time and update FOBO. Typically, auto adjustments are pre-configured with the correct GL posting code for easy distribution in the system. In various embodiments, the adjustments allow straight through processing, where the entire trade process for capital markets and payment transactions can be conducted electronically without any manual intervention. In various embodiments, the auto adjustment allows changes to be made both to debit and credit entries.

In various embodiments, the reconciling module reconciles data multiple times during the trading day by associating at least one debit and credit with the data to be reconciled. In various embodiments, the reconciling module associates at least one debit and credit from the front office with data from at least one debit and credit from the back office.

In various embodiments, the system reconciles financial data in a front office environment, by obtaining a first front office data input into the database prior to close of a trading day, wherein the first front office data input comprises at least a first tracked adjustment (e.g., a manual or automatic adjustment made to financial transaction data); obtaining a second front office data input into a database prior to the close of the trading day, wherein the second front office data input comprises at least a second tracked adjustment (e.g., a manual or automatic adjustment made to financial transaction data); locking down and signing off the first front office data input and the second front office data input and storing it in the database; and performing a reconciliation between the first front office data input and the second front office data input, wherein the reconciliation includes at least one of the first tracked adjustment and the second tracked adjustment.

In various embodiments, the system allows T1 manual adjustments from the FOBO (58) (e.g., position adjustments that were not made through auto adjustments). In various embodiments, the manual adjustments can be pre-populated using static data with the reference data module. Static data includes data that changes little over time. Examples of static data include, but is not limited to, account information, metadata associated with the transaction or financial instrument, account information, lock down and signoff data, and/or the like. Book static data is static data that changes little over time for the entity or financial instrument. Examples of book static data include, but are not limited to, year end or past, market value, past P&L, past balance sheet data, past notional data, past price data, past factor data, past face data, that are unchanged in the database (e.g., include the BS, GL, 10 K or 10 Q for the year).

Reference data includes information such as, for example, names, addresses, legal entity, account information, inventories, notional data, price data, factor data, face data, that are unadjusted then adjusted, and the like. Reference data may include book static data. Book static data includes financial transaction or financial instrument portfolio hierarchies, which includes book name, entity, desk product controller, and/or instrument type. Reference data does not typically include market value, P&L and/or balance sheet data. In various embodiments, the manual adjustments made are initially set at unchangeable preset default values stored in the reference data module.

In various embodiments, the system allows reconciling financial data including profit and loss data, comprising: a) identifying an asset for purchase (e.g., financial instrument, stock, bond etc.); b) identifying an internal source of funding for purchase of the asset (e.g., a bank's financial instrument, stock, cash, etc.); c) assigning an internal transfer price to the internal source of funding for the purchase of the asset, wherein the internal transfer price is treated by the system as a cost; d) generating a funding estimate that includes the internal transfer price treated as the cost; and e) reconciling the financial data including profit and loss associated with the asset purchase using the funding estimate.

In various embodiments, the reconciling is achieved using reference data that comprises book static data and data that comprises legal entity data, market value, estimated market value, P&L, Balance Sheet, Notional, Prices, Factors, Face, which are unadjusted and then adjusted.

In various embodiments, manual adjustments are double entry (debit and credit entries) that can be passed to the GL as well. In various embodiments, the system allows T1 funding calculation, funding calculation for pre-adjusted BO sourced balance sheet. In various embodiments, automatic funding calculations are included. The systems and methods in various embodiments comprise a funding estimate for the financial transaction or instrument. The funding estimate allows an estimated value to be assigned to the financial transaction or financial instrument; such value can be internal estimate (e.g., debit item or credit item), which is then reconciled in the P&L statement or balance sheet.

In various embodiments, for T1 foreign exchange revaluation, complete valuation and revaluation of foreign exchange P&L to be reported is made. In various embodiments, the system allows foreign exchange rate feeds or the foreign exchange rate data to be entered manually at one or more user interfaces.

In various embodiments, the system allows T1 lock down and signoff, where the authorized user can lock down and signoff (34) on the actual P&L data. In various embodiments, lock down and signoff screens include daily, month to date, and year to date figures at any level of predefined business hierarchy.

In various embodiments, the system allows tracking T1 estimate to actual reporting via the tracking module. Reports can summarize P&L with daily, month to date, and year to date analysis. In various embodiments, the system allows T1 adjustments that are posted on the GL including debit and credit entries and mapping of portfolios to GL profit centers, and/or multi-currency postings. In various embodiments, the system allows adjustments made to the P&L, and BS to be posted on the GL.

In various embodiments, the system allows various types of reports for management to be produced at T0 (70), T1 (71) and/or T2 (73). In various embodiments, the system uses COGNOS software, which combines reporting, data integration, and other business intelligence features. This reporting system may be integrated with an alerts generator that will provide the user with alerts when select events occur (e.g., manual and/or automatic adjustments, etc.).

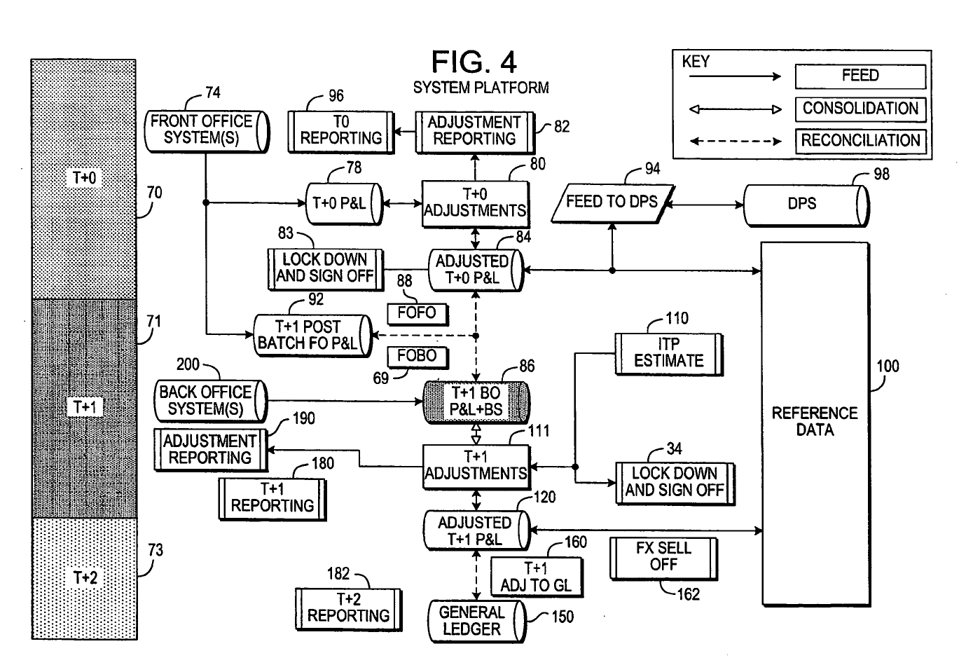

FIG. 4 illustrates the information exchange platform, in one embodiment, of the methods and systems for reconciling profit and loss at point in time T0 (70), T1 (71), and T2 (73). At time T0, FO data (74) is fed to the T0 P&L data (78), which can be reconciled with T0 adjustments (80). If adjustments are needed, they can be made at 82 and the data sent for T0 reporting (96). Once the T0 adjustments to the P&L are finalized in adjusted T0 P&L (84), they are sent for lock down and signoff (83). They are then sent to data processing (94) and stored in the data processing module (98). At point T1, there can be FOFO (88), and FOBO (69) reconciling and the data captured in T1 FO P&L (92). Adjusted T0 P&L (84) can be reconciled and fed into T1 BO P&L and BS (86) and/or there can be data feed from the BO system (200). Thus, reconciled and adjusted T1 BO P&L and BS are stored in 86. At time T1 ITP estimate (110) are fed into T1 adjustments (111). ITP includes the internal transferring price for the financial instrument and/or financial transaction. This is the funding or “cost of funds” charged by a bank to the various business lines within the bank. It allows banks to measure business performance by effectively “lending” them money at an interest rate—also known as the cost of funds rate—which generates an expense in the business P&L. The ITP is fed into T1 adjustments (111), which then can be fed into the adjustment reporting (190) and reported as T1 reporting (180). The T1 adjustments data can lead to the adjusted T1 P&L (120) and be used to adjust the GL (160) and reconciled with the GL (150), where it can be reported at a later time T2 (182), which is a time after T1. The system allows T1 lock down and signoff, where the authorized user can lock down and signoff (34) on the actual GL data. Adjustments can include foreign exchange (FX) sell off (162). FX sell off of a financial instrument may include various value realized for sale of the instrument based on fluctuations in value (e.g., currency fluctuations).

It will be apparent to those skilled in the art that various modifications and variations can be made to various embodiments described herein without departing from the spirit or scope of the teachings herein. Thus, it is intended that various embodiments cover other modifications and variations of various embodiments within the scope of the present teachings.

What is claimed:

1. A double entry bookkeeping module for a front office financial data reconciliation system, comprising a computer-readable array of fields comprising data in connection with a financial transaction or a financial instrument, the computer-readable array comprising a plurality of fields pre-populated with static data and fields to enter data to be reconciled that is associated with the financial transaction or financial instrument, wherein the double entry bookkeeping module is configured to allow the data to be reconciled during a trading day prior to the close of trading.

2. A double entry bookkeeping module for a front office financial data reconciliation system according to claim 1, wherein the module associates at least one debit and credit with the data to be reconciled.

3. A double entry bookkeeping module for a front office financial data reconciliation system according to claim 1, wherein the module reconciles data multiple times during the trading day.

4. A double entry bookkeeping module for a front office financial data reconciliation system according to claim 1, wherein the system is configured to record data associated with the financial transaction or instrument to a general ledger and reconcile the ledger by adjusting one or more account balances associated with the financial transaction or financial instrument; and comparing the adjusted balance to the balance before and after the balance was adjusted.

5. A double entry bookkeeping module for a front office financial data reconciliation system according to claim 1, wherein the system further comprises an adjustment module configured to allow adjustments to the data before or after it is reconciled and a tracking module to track adjustments made to the data, wherein the tracking module identifies the adjustment by specific user.

6. A double entry bookkeeping module for a front office financial data reconciliation system according to claim 1, wherein the module is configured to monitor pre-trade, post-trade, and real-time market value for the financial transaction or instrument.

7. A double entry bookkeeping module for a front office financial data reconciliation system according to claim 1, wherein the module associates at least one debit and credit from the front office with data from at least one debit and credit from the back office.

8. A double entry bookkeeping module for a front office financial data reconciliation system according to claim 1, wherein the system is a network based system.

9. A double entry bookkeeping module for a front office financial data reconciliation system according to claim 1, wherein the system is configured to be protected from access by unauthorized users.

10. A double entry bookkeeping module for a front office financial data reconciliation system according to claim 1, wherein the system comprises a reports generator to generate reports before, during and after the close of the trading day.

11. A double entry bookkeeping module for a front office financial data reconciliation system according to claim 5, wherein the system comprises an alerts generator that alerts an authorized user when an adjustment has been made.

12. A system for reconciling financial data including profit and loss data, comprising: a) identifying an asset for purchase; b) identifying an internal source of funding for purchase of the asset; c) assigning an internal transfer price to the internal source of funding for the purchase of the asset, wherein the internal transfer price is treated by the system as a cost; d) generating a funding estimate that includes the internal transfer price treated as the cost; and e) reconciling the financial data including profit and loss associated with the asset purchase using the funding estimate.

13. A system for reconciling financial data according to claim 12, wherein the reconciling is achieved using reference data that comprises book static data and data that comprises legal entity data, market value, estimated market value, P&L, Balance Sheet, Notional, Prices, Factors, Face, which are unadjusted and then adjusted.

14. A system for reconciling financial data according to claim 13, wherein the financial data comprises profit and loss data collected during a trading day and the system further comprises an adjustments module configured to allow adjustments to the financial data to be made at a time (T0) during a trading day in advance of a final reconciliation period for financial data generated during the trading day.

15. A system for reconciling financial data in a front office environment, comprising:
a. obtaining a first front office data input into a database prior to close of a trading day, wherein the first front office data input comprises at least a first tracked adjustment;
b. obtaining a second front office data input into a database prior to the close of the trading day, wherein the second front office data input comprises at least a second tracked adjustment;
c. locking down and signing off the first front office data input and the second front office data input and storing it in the database; and
d. performing a reconciliation between the first front office data input and the second front office data input, wherein the reconciliation includes at least one of the first tracked adjustment and the second tracked adjustment.

16. A system for reconciling financial data according to claim 15, wherein first and second tracked data comprises at least one debit and credit associated with a financial transaction or instrument.

17. A system for reconciling financial data according to claim 15, wherein the system comprises a lock down component configured to prevent altering of the financial data at a certain period of time and a signoff component to allow an authorized user to provide a digital signature to verify the integrity of the financial data.

18. A system for reconciling financial data according to claim 15, wherein the system is configured to store the financial data in a general ledger.

19. A system for reconciling financial data according to claim 15, wherein the reconciliation includes associating at least one debit and credit from the front office with data from at least one debit and credit from the back office.

20. A system for reconciling financial data according to claim 15, wherein the system is a network based system.

21. A system for reconciling financial data according to claim 15, wherein the system is configured to be protected from access by unauthorized users.

22. A system for reconciling financial data according to claim 15, wherein the system comprises a reports generator to generate reports before, during and after the close of a trading day.

23. A system for reconciling financial data according to claim 22, wherein the system generates a risk report for the data stored in the database.

24. A network based system for reconciling financial data to a general ledger, the system comprising: a financial data module configured to receive or transmit data from a front office and/or back office concerning a financial transaction or a financial instrument; an adjustments module coupled to the financial data module configured to adjust the data received or transmitted from the front office and/or back office; a tracking module coupled to the financial data module configured to track adjustments made to the financial data; a reconciling module coupled to the data module configured to reconcile financial data from the front office and/or back office; and a lock down and signoff module coupled to the financial data module configured to prevent altering of the financial data and allow an authorized user to provide a digital signature to verify the integrity of the financial data at a close of business day.

25. A computer readable storage medium storing instructions that, when executed by a computer, cause the computer to receive or transmit financial data from a front office and/or back office concerning a financial transaction or a financial instrument; adjust the data received or transmitted from the front office and/or back office; track adjustments made to the financial data; reconcile financial data from the front office and/or back office; and prevent altering of the financial data and allow an authorized user to provide a digital signature to verify the integrity of the financial data at a close of business day.
